(19) United States
(12) Patent Application Publication
(10) Pub. No.: US 2009/0023625 A1
(43) Pub. Date: Jan. 22, 2009

(54) Detergent composition containing suds boosting co-surfactant and suds stabilizing surface active polymer

(76) Inventors: Ming Tang, Beijing (CN); Yongmei Sun, Beijing (CN); Kenneth Nathan Price, Cincinnati, OH (US); Suxuan Gong, Beijing (CN); Sen Liu, Beijing (CN); Stacie Ellen Hecht, West Chester, OH (US); Mark Robert Sivik, Mason, OH (US); Peng Yan, Beijing (CN)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/214,874

(22) Filed: Jun. 23, 2008

Related U.S. Application Data
(60) Provisional application No. 60/961,184, filed on Jul. 19, 2007.

(51) Int. Cl. C11D 7/42; C11D 3/34

(52) U.S. Cl. 510/320; 510/357

(57) ABSTRACT

A detergent composition having improved sudsing profile comprising 0.2% to 6% by weight of a suds boosting co-surfactant having the formula R—O—(CH₂CH₂O)ₙSO₃⁻M⁺, wherein R is a branched or unbranched alkyl group having 8 to 16 carbon atoms, n is an integer from 0 to 3, M is a cation of alkali metal, alkaline earth metal or ammonium; 0.01% to 5% by weight of a surface active polymer having the properties: (i) the surface tension of a 39 ppm polymer solution in distilled water is from 40 mN/m to 65 mN/m as measured at 25° C. by a tensiometer; and (ii) the viscosity of a 500 ppm polymer solution in distilled water is from 0.0009 to 0.003 Pa·S as measured at 25° C. by a rheometer; and 6% to 15% by weight of a main surfactant system. The total surfactant level in the detergent composition is less than 20% and the phosphate and/or aluminosilicate builder level in the detergent composition is less than 15% by weight.

### CROSS REFERENCE TO RELATED APPLICATION

This application claims the benefit of U.S. Provisional Application No. 60/961184, filed Jul. 19, 2007.

### FIELD OF THE INVENTION

The present invention relates to a high sudsing detergent composition. Specifically, the present invention relates to a detergent composition containing a reduced level of total surfactant and phosphate and/or aluminosilicate builder without apparently deteriorating the sudsing profile of the detergent composition.

### BACKGROUND OF THE INVENTION

Although automatic mechanical washing has been widely accepted and used nowadays, there are still many situations where people need to do hand-washing, such as the washing needs for delicate garments, dishes and/or items which need special care. Indeed, in most developing countries, consumers' washing habit for laundry is to wash their garments with either non-automated top loaded washing machines (i.e. apparatus which comprises two separated tubs, one for washing or rinsing, and one for spinning), or in basins or buckets. The washing in basins or buckets and non-automated top loaded washing machines involves the steps of washing with detergent, wringing or spinning, and rinsing one or more times with water.

Sudsing profile of a detergent composition, including but not be limited to speed and volume of suds generated upon dissolving the detergent composition in a washing solution, retention of suds during washing cycle and easiness in rinsing the suds in rinsing cycle is highly valued by consumers doing hand-washing and non-automated top loaded laundry machine-washing. Suds are viewed by such consumers as an important signal that detergent is ‘working’ and as an active driver of accomplishing their cleaning objectives. Thus, rapidly generated high volume of suds and well retained suds during washing cycle are highly preferred. On the other hand, high volume of suds in the washing cycle typically results in suds being carried over to the rinse bath solution and requiring additional time, energy and water to thoroughly rinse the laundered items. Accordingly, quick collapse of suds in rinsing solution is another preferred aspect of the sudsing profile of a detergent composition.

Also, a commonly known and widely used high suds detergent in the art typically comprises a high level of surfactant and builder, such as more than 20% of surfactant and more than 15% of builder. Recently, the impact of such materials on the environment has become a serious concern as such materials exhaust un-reproducible natural resources and will be ultimately discharged into rivers and lakes. Hence, there is still a need for a detergent composition having reduced level of surfactant and/or builder, or even without builder. However, one difficulty in meeting this need is that the reduction of surfactant and/or builder in a detergent composition significantly deteriorates the sudsing profile of the detergent composition; for example, the suds generation speed and volume of suds generated is low, and suds are not well retained during the washing cycle as soils dissolved in the washing solution depress suds. Such a detergent composition with poor sudsing profile is unacceptable to consumers who highly value the sudsing profile of the detergent composition.

Accordingly, there remains a need for a detergent composition containing a reduced level of total surfactant and/or builders while the sudsing profile of the detergent composition is not apparently deteriorated, i.e. a high volume of suds is generated quickly upon dissolving the detergent composition in a washing solution and suds is well-retained during washing cycle.

### SUMMARY OF THE INVENTION

The present invention relates to a detergent composition comprising from about 6% to about 15% by weight of a main surfactant system, from about 0.2% to about 6% by weight of one or more suds boosting co-surfactants and from about 0.01% to about 5% by weight of a surface active polymer, wherein the detergent composition comprises less than 20% by weight of total surfactant and less than 15% by weight of a phosphate and/or aluminosilicate builder. As used herein, a main surfactant system refers to one or more surfactants selected from the group consisting of an anionic surfactant other than the suds boosting co-surfactant, a nonionic surfactant, a cationic surfactant and a zwitterionic surfactant. In addition to the main surfactant system, the detergent composition herein contains a suds-boosting co-surfactant having the following formula (I):

R—O—(CH₂CH₂O)ₙSO₃⁻M⁺ (I)

wherein R is a branched or unbranched alkyl group having from about 8 to about 16 carbon atoms, n is an integer from 0 to 3, M is a cation of alkali metal, alkaline earth metal or ammonium. The surface active polymer useful herein has the properties of (i) the surface tension of a 39 ppm by weight polymer solution in distilled water is from about 40 mN/m to about 65 mN/m as measured at 25° C. by a tensiometer; and (ii) the viscosity of a 500 ppm by weight polymer solution in distilled water is from about 0.0009 to about 0.003 Pa·S as measured at 25° C. by a rheometer.

It has been surprisingly found that the detergent composition herein, although contains reduced level of total surfactant and phosphate and/or alumosilicate builder, or even no builder, still has an improved sudsing profile. Without intending to be bound by theory, the suds-boosting co-surfactant herein has a higher critical micelle concentration (CMC) and a bigger packing area than surfactants typically used for cleaning purpose in laundry detergent, in addition, the mixed micelle of co-surfactant and main surfactant has an improved tolerance to the hardness of the washing water; therefore, it is believed that more surfactant monomers are available to participate in generating suds and thus quickly-generated high volume of suds can be obtained. In addition, the surface active polymer in the detergent composition may go to the air-water interface in the washing solution and stay in the suds film lamellae due to its specific properties and as a result, the viscoelascity of the suds film is increased and undesirable drainage of suds during washing cycle is substantially delayed. In the rinsing cycle, suds collapse quickly due to the breakage of the mixed micelle of co-surfactant and main surfactant and dilution of the surface active polymer.

### DETAILED DESCRIPTION OF THE INVENTION

As used herein, “sudsing profile” refers to the properties of a detergent composition relating to suds character in washing and rinsing solutions. The sudsing profile of a detergent composition includes but is not be limited to the speed of suds generation upon dissolving the detergent composition, the volume and retention of suds in the washing cycle, and the ease of rinsing the suds away in the rinsing cycle.

As used herein, “main surfactant system” refers to one or more surfactants contained in the detergent composition herein other than the suds generating co-surfactants. In the context of this invention, the main surfactant system presents in the detergent composition herein at a level of more than 50%, or more than 75% by weight of the total amount of surfactants contained in the detergent composition.

As used herein, “co-surfactant” refers to one or more surfactants in a detergent composition which is mainly used to improve the sudsing profile of the detergent composition. The level of co-surfactant is typically less than 50%, or less than 25% by weight of the total amount of surfactants in the detergent composition.

All percentages, ratios and proportions herein are by weight, unless otherwise specified. All temperatures herein are in degrees Celsius (° C.) unless otherwise indicated. All molecular weight of a polymer means weight average molecular weight of the polymer obtained by standard analytical methods as described in polymer handbooks, unless otherwise indicated. A preferred method is light scattering from polymer solutions as originally defined by Debye.

### Suds Boosting Co-Surfactant

The detergent composition herein comprises from about 0.2% to about 6%, or from about 0.3% to about 4%, or from about 0.4% to about 3% by weight of a suds boosting co-surfactant having the following formula (I):

R—O—(CH₂CH₂O)ₙSO₃⁻M⁺ (I)

wherein R is a branched or unbranched alkyl group having from about 8 to about 16 carbon atoms, n is an integer of from 0 to 3, M is a cation of alkali metal, alkaline earth metal or ammonium.

It has been surprisingly found that the co-surfactant herein significantly improves the sudsing profile, especially suds boosting property of the detergent composition. By “suds boosting”, it means suds are generated rapidly upon the dissolution of the detergent composition in a washing solution and a high volume of suds is generated during the washing cycle. In addition, inventors of the present invention have surprisingly found that when the suds boosting co-surfactant is present in the detergent composition herein at a level of lower than 0.2% by weight, it does not give necessary suds boosting benefit, on the other hand, when the suds boosting co-surfactant is present in the detergent composition herein at a level of more than 6% by weight, the suds boosting performance of the co-surfactant is not appreciably improved with the level increase of the suds boosting co-surfactant in the detergent composition.

Preferred suds boosting co-surfactant herein is a C10-C14 linear alkyl sulphate, such as a sodium salt of C10-C14 linear alkyl sulphate, i.e., a co-surfactant of formula (I), wherein the R group is a C10-C14 linear alkyl group, n is 0. Non-limiting linear alkyl sulphates useful herein as the suds boosting co-surfactants are sodium decyl sulfate, sodium lauryl sulfate, sodium tetradecyl sulfate, and mixtures thereof. All of these surfactants are well known in the art and are commercially available from a variety of sources.

Another preferred suds boosting co-surfactant herein is a branched alkyl sulphate optionally condensed with from 1 to 3 moles of ethylene oxide, i.e. a surfactant of formula (I), wherein R is a branched alkyl group. Illustrative branched R group include a branched alkyl group having the following formula (II):

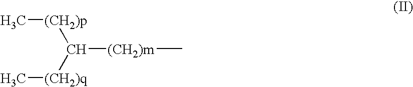

wherein p, q and m are independently selected from integers of from 0 to 13, provided that 5≦p+q+m≦13.

Non-limiting examples of suitable branched alkyl sulphate and branched alkyl ethoxylated sulfate include surfactants having the following chemical structures:

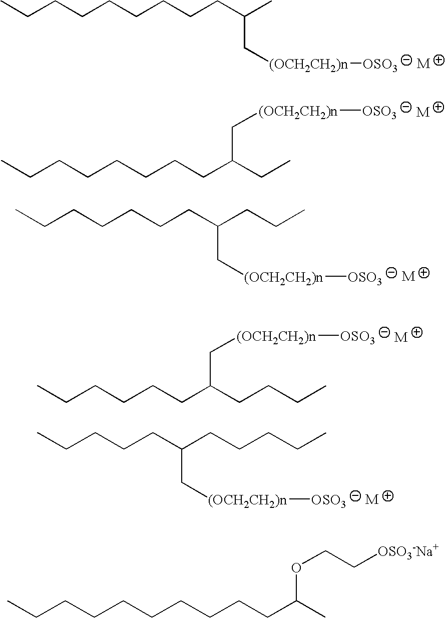

Branched alkyl sulfates and branched alkyl ethoxylated sulfates are commercially available normally as a mixture of linear isomer and branched isomer with a variety of chain lengths, degrees of ethoxylation and degrees of branching. Such as Empimin® KSL68/A and Empimin® KSN70/LA by Albright & Wilson with C12/13 chain length distribution, about 60% branching and having an average ethoxylation of 1 and 3, Dobanol® 23 ethoxylated sulphates from Shell with C12/13 chain length distribution, about 18% branching and having an average ethoxylation of 0.1 to 3, sulphated Lial® 123 ethoxylates from Condea Augusta with C12/13 chain length distribution, about 60% branching and an average ethoxylation of 0.1 to 3 and sulphated Isalchem® 123 alkoxylates with C12/13 chain length distribution and about 95% branching.

Also, suitable alkyl ethoxylated sulfates can be prepared by ethoxylating and sulfating the appropriate alcohols, as described in “Surfactants in Consumer Products” edited by J. Falbe and “Fatty oxo-alcohols: Relation between the alkyl chain structure and the performance of the derived AE, AS, AES” submitted to the 4th World Surfactants, Barcelona, 3-7 VI 1996 Congress by Condea Augusta. Commercial oxo-alcohols are a mixture of primary alcohols containing several isomers and homologues. Industrial processes allow one to separate these isomers hence resulting in alcohols with linear isomer content ranging from 5-10% to up to 95%. Examples of available alcohols for ethoxylation and sulfation are Lial® alcohols by Condea Augusta (60% branched), Isalchem® alcohols by Condea Augusta (95% branched), Dobanol® alcohols by Shell (18% linear).

Additional process for preparing branched alkyl sulfates and branched ethoxylated sulfates are for example described in U.S. Pat. No. 6,020,303, U.S. Pat. No. 6,060,443, U.S. Pat. No. 6,008,181 and U.S. Pat. No. 6,020,303.

### Main Surfactant System

The detergent composition herein comprises from about 6% to about 15%, or from about 8% to about 15%, or from about 10% to about 14% by weight of a main surfactant system comprising one or more surfactants selected from the group consisting of an anionic surfactant other than the suds boosting co-surfactant, a nonionic surfactant, a cationic surfactants and a zwitterionic surfactant.

Suitable anionic surfactants useful as a component of the main surfactant system herein can be any of the conventional anionic surfactant types typically used in liquid and/or solid detergent products with the exclusion of the suds boosting co-surfactants defined hereinabove. Non-limiting suitable anionic surfactant can be C11-C18 alkyl benzene sulfonates and sulfonated fatty acid alkyl ester. Exemplary C11-C18 alkyl benzene sulfonates are the alkali metal salts of C11-18 linear alkyl benzene sulfonic acids known as “LAS” and modified alkyl benzene sulfonate (MLAS) as discussed in WO 99/05243, WO 99/05242, WO 99/05244, WO 99/05082, WO 99/05084, WO 99/05241, WO 99/07656, WO 00/23549, and WO 00/23548. Linear alkyl benzene sulfonates are well known in the art. Such surfactants and their preparation are described for example in U.S. Pat. Nos. 2,220,099 and 2,477,383. Especially preferred are the sodium and potassium linear straight chain alkyl benzene sulfonates in which the average number of carbon atoms in the alkyl group is from about 11 to 14. Sodium C11-C14, e.g., C12 LAS is a specific example of such surfactants.

Exemplary sulfonated fatty acid alkyl ester surfactant comprises those of the following formula (III):

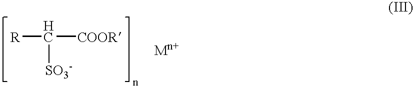

wherein R is, on the average, a C4 to C22 alkyl, R′ is on the average a C1 to C8 alkyl, M is an alkali metal or alkaline earth metal cation, or a mixture thereof, and n is 1 when M is an alkali metal cation and n is 2 when M is an alkaline earth metal cation.

The sulfonate group is positioned at the carbon atom adjacent the carbonyl group. The hydrophobic portion, which corresponds to the R group in formula (III) is, on the average a C4 to C22 alkyl. Preferably, R is, on the average a saturated straight-chain C10 to C16 hydrocarbon particularly when R′ is methyl. R′, forming the ester portion of the sulfonated fatty acid alkyl esters, is on the average a C1 to C8 alkyl. Preferably, R′ is on the average a C1 to C6 alkyl, and most preferably a methyl.

When considered together, R and R′ preferably contain a total of about 11 to 17 carbons. In one embodiment, R is, on the average, a C14 to C16 alkyl and R′ is methyl. In another embodiment, R is, on the average, a C12 to C16 alkyl and R′ is methyl. In yet further another embodiment, R is, on the average, a C10 to C14 alkyl and R′ is methyl. Preferably, M is chosen from sodium, potassium, lithium, magnesium and calcium, and mixtures thereof. Most preferably, M is sodium or a mixture containing sodium.

Methods for making sulfonated fatty acid alkyl ester surfactants have been well described and are known to those skilled in the art. See U.S. Pat. Nos. 4,671,900; 4,816,188; 5,329,030; 5,382,677; 5,384,422; 5,475,134; 5,587,500; 6,780,830.

Suitable nonionic surfactants useful herein can be any of the conventional nonionic surfactants typically used in detergent products. These include alkoxylated fatty alcohols and amine oxide surfactants. Suitable alcohol alkoxylate nonionic surfactants useful herein may correspond to the general formula: R(CₘH₂ₘO)ₙOH, wherein R is a C8-C16 alkyl group, m is from 2 to 4, and n is more than 3 to 12. Another suitable type of nonionic surfactant useful herein is amine oxide surfactants. Amine oxides are materials which are often referred to in the art as “semi-polar” nonionics. Amine oxides have the formula: R(EO)x(PO)y(BO)zN(O)(CH₂R′)2. In this formula, R is a relatively long-chain hydrocarbyl moiety which can be saturated or unsaturated, linear or branched, and can contain from 8 to 20, or from 10 to 16 carbon atoms. R′ is a short-chain moiety, preferably selected from hydrogen, methyl and —CH₂OH. When x+y+z is different from 0, EO is ethyleneoxy, PO is propyleneneoxy and BO is butyleneoxy. Amine oxide surfactants are illustrated by C12-14 alkyldimethyl amine oxide.

Cationic surfactants are well known in the art and non-limiting examples of these include quaternary ammonium surfactants, which can have up to 26 carbon atoms. Specific examples include a) alkoxylate quaternary ammonium (AQA) surfactants as discussed in U.S. Pat. No. 6,136,769; b) dimethyl hydroxyethyl quaternary ammonium as discussed in U.S. Pat. No. 6,004,922; c) polyamine cationic surfactants as discussed in WO 98/35002, WO 98/35003, WO 98/35004, WO 98/35005, and WO 98/35006; d) cationic ester surfactants as discussed in U.S. Pat. Nos. 4,228,042, 4,239,660 4,260,529 and U.S. Pat. No. 6,022,844; and e) amino surfactants as discussed in U.S. Pat. No. 6,221,825 and WO 00/47708, specifically amido propyldimethyl amine (APA).

Non-limiting examples of zwitterionic surfactants include: derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 to Laughlin et al., issued Dec. 30, 1975 at column 19, line 38 through column 22, line 48, for examples of zwitterionic surfactants; betaine, including alkyl dimethyl betaine and cocodimethyl amidopropyl betaine, C8 to C18 (preferably C12 to C18) amine oxides and sulfo and hydroxy betaines, such as N-alkyl-N,N-dimethylammino-1-propane sulfonate where the alkyl group can be C8 to C18, preferably C10 to C14.

### Surface Active Polymer

The detergent composition herein contains from about 0.01% to about 5%, or from about 0.1% to about 2% by weight of a surface active polymer. Surface active polymers have been used in detergent compositions mainly for the purpose of improving cleaning performance. However, inventors of the present invention have found that surface active polymers having specified properties perform synergistically with the suds boosting co-surfactant in improving the sudsing profile of the laundry detergent composition. Without intending to be bound by theory, it is believed that the suds boosting co-surfactant herein improves suds generation speed and volume of suds generated upon dissolving the detergent composition in a washing solution, while the surface active polymer stabilizes the suds during the washing cycle so that the undesirable drainage of suds can be substantially delayed. Specifically, the surface active polymer herein has the following properties:

(i) the surface tension of a 39 ppm by weight polymer solution in distilled water is from about 40 mN/m to about 65 mN/m as measured at 25° C. by a tensiometer; and

(ii) the viscosity of a 500 ppm by weight polymer solution in distilled water is from about 0.0009 to about 0.003 Pa·S as measured at 25° C. by a rheometer.

Without intending to be bound by theory, it is believed that a surface active polymer having the above defined properties may go to the air-water interface of a washing solution and stay in suds film; as a result, the viscoelasticity of the suds film is increased and undesirable drainage of suds during the washing cycle can be substantially delayed. The surface tension of the polymer solution can be measured by any known tensiometer under the specified conditions. Non-limiting tensiometer useful herein include Kruss K12 tensiomerter available from Kruss, Thermo DSCA322 tensiometer from Thermo Cahn, or Sigma 700 tensiometer from KSV Instrument Ltd. Similarly, the viscosity of the polymer solution can be measured by any known rheometer under the specified conditions. The most commonly used rheometer is a rheometer with rotational method, which is also called a stress/strain rheometer. Non-limiting rheometers useful herein include Hakke Mars rheometer from Thermo, Physica 2000 rheometer from Anton Paar.

An exemplary first group of surface active polymers suitable for use herein are synthetic co-polymers comprising both hydrophilic and hydrophobic monomers and having a weight average molecular weight of from about 4,000 to about 100,000, or from about 6,000 to about 60,000, wherein said hydrophobic monomers is present at the level of from about 2% to about 60%, or from about 3% to about 45% by weight of the total molecular weight of the co-polymer. As used herein, hydrophilic monomers refer to monomers which are sufficiently soluble in water to form at least 1% by weight of a water solution at 25° C.; hydrophobic monomers refer to monomers which have a water solubility of less than 1% by weight, preferably less than 0.5% by weight at 25° C. The water solubility of monomers can be determined by any appropriate instrumental method through a level study after stirring 24 hours to ensure saturation has been achieved. The water solubility of many common monomers can be found in Monomers: A Collection of Data & Procedures on Basic Materials for the Synthesis of Fibers, Plastics & Rubbers Ed. E. R. Blout, H. Mark (Interscience, NY, 1951) and Kirk Othmer Encyclopedia of Chemical Technology 4th Edition, Volume 15, page 55.

Non-limiting hydrophilic monomers include ethylenically unsaturated hydrophilic monomers and polymerizable hydrophilic cyclic monomers. Exemplary ethylenically unsaturated hydrophilic monomers include acrylic acid, methacrylic acid, ethacrylic acid, alpha-chloro-acrylic acid, alpha-cyano acrylic acid, beta-methyl-acrylic acid (crotonic acid), alpha-phenyl acrylic acid, beta-acryloxy propionic acid, sorbic acid, alpha-chloro sorbic acid, angelic acid, cinnamic acid, p-chloro cinnamic acid, beta-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, 2-acryloxypropionic acid, 2-acrylamido-2-methyl propane sulfonic acid, vinyl sulfonic acid, vinyl phosphonic acid, 2-hydroxy ethyl acrylate, tri methyl propane triacrylate, sodium methallyl sulfonate, sulfonated styrene, allyloxybenzenesulfonic acid, dimethylacrylamide, dimethylaminopropylmethacrylate, diethylaminopropylmethacrylate, vinyl formamide, vinyl acetamide, polyethylene glycol esters of acrylic acid and methacrylic acid and itaconic acid, vinyl pyrrolidone, and vinyl imidazole. Suitable polymerizable hydrophilic cyclic monomers may have cyclic units that are either unsaturated or contain groups capable of forming inter-monomer linkages. In linking such cyclic monomers, the ring-structure of the monomers may either be kept intact, or the ring structure may be disrupted to form the backbone structure. Preferably, the hydrophilic monomers are selected from the group consisting of ethylene oxide, acrylic acid, methacrylic acid, maleic acid, vinyl alcohol, 2-acrylamido-2-methylpropanesulfonic acid, sodium methylallyl sulfonate and mixtures thereof.

Non-limiting hydrophobic monomers include siloxane, C4-25 unsaturated hydrocarbons, polymeriable hydrophobic cyclic monomers, vinyl esters of saturated monocarboxylic acid containing from 1 to 6 carbon atoms, C1-16 alkyl ester of (meth)acrylate; or mixtures thereof. As used herein, “alkyl(meth)acrylate” refers to either alkyl acrylate or alkyl methacrylate. Non-limiting examples of hydrophobic monomers include styrene, α-methyl styrene, methyl(meth)acrylate, 2-ethylhexyl(meth)acrylate, octyl(meth)acrylate, lauryl(meth)acrylate, stearyl(meth)acrylate, behenyl(meth)acrylate, 2-ethylhexyl acrylamide, octylacrylamide, lauryl acrylamide, stearyl acrylamide, behenyl acrylamide, propyl acrylate, butyl acrylate, pentyl acrylate, hexyl acrylate, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, and 4-(phenylbutyl)styrene, vinyl acetate, vinyl propionate, vinyl butyrate, propylene oxide, butylenen oxide. Preferably, the hydrophobic monomers are selected from the group consisting of styrene, propylene oxide, butylene oxide, vinyl acetate, vinyl propionate, vinyl butyrate, methyl(meth)acrylate, butyl(meth)acrylate, hexyl(meth)acrylate, lauryl acrylate, cetyl acrylate, siloxane, ethylene, N-vinylpyrrolidone and mixtures thereof.

In one embodiment herein, the surface active co-polymer is a graft co-polymer comprising a hydrophilic backbone and one or more hydrophobic side chains. The hydrophilic backbone contains hydrophilic monomers as described herein above. The hydrophilic backbone may also contain small amounts of relatively hydrophobic monomers, provided that the overall solubility of the backbones in water at ambient condition is more than 1% by weight. The graft co-polymer further comprises a plurality of hydrophobic side chains. The hydrophobic side chains contain hydrophobic monomers as described above herein above. The hydrophobic side chains of the polymer may also contain small amounts of relatively hydrophilic monomers, provided that the overall solubility of the backbones of the polymer in water at ambient temperature is less than 1% by weight.

Specific preferred non-limiting graft co-polymer suitable for use herein contains from about 20% to about 70%, or from about 25% to about 60% by weight of water-soluble polyalkylene oxides (A) as a backbone and from about 30% to about 80%, or from about 40% to about 75% by weight of side chains formed by polymerization of a vinyl ester component (B) containing from about 70% to about 100% by weight of vinyl acetate and/or vinyl propionate (B1) and if desired, from 0 to 30% by weight of a further ethylenically unsaturated monomer (B2), in the presence of (A).

Water-soluble polyalkylene oxides suitable for forming the backbone are in principle all polymers based on C2-C4 alkylene oxides which comprise at least 50%, or at least 60%, or at least 75% by weight of ethylene oxide in copolymerized form. The polyalkylene oxides (A) may be the corresponding polyalkylene glycols in free form, i.e. with OH end groups, but they may also be capped at one or both ends. Suitable end groups are, for example, C1-C25 alkyl, phenyl and C1-C14 alkylphenyl groups.

Specific examples of particularly suitable polyalkylene oxides (A) backbones include:

(A1) polyethylene glycols which may be capped at one or both ends, especially by C1-C25 alkyl groups, but are preferably not etherified, and have mean number average molecular weight, Mn of from 1,500 to 20,000, or from 2,500 to 15,000;

(A2) copolymers of ethylene oxide and propylene oxide and/or butylene oxide with an ethylene oxide content of at least 50% by weight, which may likewise be capped at one or both ends, especially by C1-C25 alkyl groups, but are preferably not etherified, and have mean number average molecular weight, Mn of from 1,500 to 20,000, or from 2,500 to 15,000;

(A3) chain-extended products having mean number average molecular weight of from 2,500 to 20,000, which are obtainable by reacting polyethylene glycols (A1) having mean number average molecular weight, Mn of from 200 to 5,000 or copolymers (A2) having mean number average molecular weight, Mn of from 200 to 5,000 with C2-C12 dicarboxylic acids or C2-C12 dicarboxylic esters or C6-C18-diisocyanates.

Preferred hydrophilic backbone (A) is the polyethylene glycols (A1).

The side chains of said specific preferred polyalkylene oxide graft co-polymers are formed by polymerization of a vinyl ester component (B) in the presence of the hydrophilic backbone (A). The vinyl ester component (B) may consist advantageously of (B1) vinyl acetate or vinyl propionate or mixtures thereof, particular preference is vinyl acetate. However, the side chains of the graft polymer can also be formed by copolymerizing vinyl acetate and/or vinyl propionate (B1) and a further ethylenically unsaturated monomer (B2). The fraction of monomer (B2) in the vinyl ester component (B) may be up to 30%, or from 1 to 15%, or from 2 to 10% by weight of the side chains. Suitable comonomers (B2) are, for example, monoethylenically unsaturated carboxylic acids and dicarboxylic acids and their derivatives, such as esters, amides and anhydrides, and styrene, or mixtures thereof. Specific examples include: (meth)acrylic acid, C1-C12 alkyl and hydroxy C2-C12 alkyl esters of (meth)acrylic acid, (meth)acrylamide, N—C1-C12-alkyl(meth)acrylamide, N,N-di(C1-C6-alkyl)(meth)acrylamide, maleic acid, maleic anhydride and mono(C1-C12 alkyl) esters of maleic acid.

Preferred monomers (B2) are the C1-C8 alkyl esters of (meth)acrylic acid and hydroxyethyl acrylate, more preferably, C1-C4 alkyl esters of (meth)acrylic acid. Specific preferred monomers (B2) are methyl acrylate, ethyl acrylate and n-butyl acrylate.

Said specific preferred polyalkylene oxides graft co-polymers have a mean weight average molecular weight, Mw of from about 3,000 to about 100,000, or from about 6,000 to about 45,000, or from about 8,000 to about 30,000 and an average of no more than 1 graft site, or no more than 0.6 graft site, or no more than 0.5 graft site per 50 alkylene oxide units. The degree of grafting can be determined, for example, by means of 13C NMR spectroscopy from the integrals of the signals of the graft sites and the —CH2-groups of the polyalkylene oxide. These graft polymers can be prepared by polymerizing a vinyl ester component (B) composed of vinyl acetate and/or vinyl propionate (B1) and, if desired, a further ethylenically unsaturated monomer (B2), in the presence of a water-soluble polyalkylene oxide (A), a free radical-forming initiator (C) and, if desired, up to 40% by weight, based on the sum of components (A), (B) and (C), of an organic solvent (D), at a mean polymerization temperature at which the initiator (C) has a decomposition half-life of from 40 to 500 min, in such a way that the fraction of unconverted graft monomer (B) and initiator (C) in the reaction mixture is constantly kept in a quantitative deficiency relative to the polyalkylene oxide (A), see detailed description in EP06114756. In accordance with their low degree of branching, the molar ratio of grafted to ungrafted alkylene oxide units in the graft co-polymers is from 0.002 to 0.05, or from 0.002 to 0.035, or from 0.003 to 0.025, or from 0.004 to 0.02.

More preferably, said specific preferred polyalkylene oxides graft co-polymers feature a narrow molar weight distribution and hence a polydispersity Mw/Mn of generally 3, preferably 2.5 and more preferably 2.3. Most preferably, their polydispersity Mw/Mn is in the range of from 1.5 to 2.2. The polydispersity of the graft polymers can be determined, for example, by gel permeation chromatography using narrow-distribution polymethyl methacrylates as the standard.

The second group of surface active polymers suitable for use herein is water-soluble modified polysaccharides having a weight average molecular weight of from about 10,000 to about 4,000,000, or from about 20,000 to about 900,000, or from about 30,000 to about 80,000. The term “polysaccharide” includes straight or branched chain polymers made up of monosaccharide units linked by glycoside linkages. The molecular weight of a polysaccharide is normally higher than about 5,000 and up into the millions of daltons. They are normally naturally occurring polymers, such as, starch, glycogen, cellulose, gum arabic, agar and chitin. The most useful of the polysaccharides for the purposes of this invention are cellulose and starch. In the context of the present invention, a natural polysaccharide or hydrolyzed polysaccharide without any modification is also referred to as a polysaccharide backbone. The polysaccharide backbone can be modified by various techniques to impart the modified polysaccharide with the specified surface active properties. In a preferred embodiment, polysaccharide backbone is hydrophobically modified by specified substitute groups attached to the polysaccharide backbone through the hydroxyl groups. The amount of the substitutes in the modified polysaccharide can be defined by degree of substitution (DS). As used herein, “degree of substitution” of modified polysaccharide is an average measure of the number of hydroxyl groups on each monosaccharide unit which are derivitised by substitutent groups. The degree of substitution is expressed as the number of moles of substituent groups per mole of monosaccharide unit, on a molar average basis. The degree of substitution of a modified polysaccharide can be determined using proton nuclear magnetic resonance spectroscopy (“¹H NMR”) methods well-known in the art. Suitable ¹H NMR technical include those described in “Observation on NMR Spectra of Starches in Dimethyl Sulfoxide, Iodine-Complexing, and Solvating in Water-Dimethyl Sulfoxide”, Qin-Ji Peng and Arthur S. Perlin, Cabohydrate Research, 160 (1987), 57-72; and “An Approach to the Structural Analysis of Oligosaccharides by NMR Spectroscopy”, J. Howard Bradbury and J. Grant Collians, Carbohydrate Research, 71 (1979), 15-25.

In one embodiment herein, the modified polysaccharide contains hydrophobic substitutes selected from alkyl, hydroxyalkyl, carboxyl alkyl, alkyl acetate or mixtures thereof with a degree of substitution of from about 0.05 to about 1.2, or from about 0.1 to about 0.8 obtained by reacting the polysaccharide backbone with various alkylating, hydroxyalkylating and/or carboxylalkylating agents. Preferably, the polysaccharide backbone is a starch or cellulose. The starch can be any native starch and includes those derived from corn, wheat, rice, oat, cassava, potato, tapioca, etc. Alternatively, acid or enzymatically degraded starch or oxidized starch, or mixtures thereof can also be used. Cellulose is generally obtained from vegetable tissues and fibres, including cotton and wood pulp. Non-limiting hydrophobic substitutes include C1-C4 alkyl, C1-C4 hydroxyalkyl, C1-C4 carboxyl alkyl, C1-C4 alkyl acetate, such as hydroxybutyl, hydroxypropyl, hydroxyethyl, methoxyl, methyl, ethyl, propyl, butyl, carboxyl methyl, carboxyl ethyl, carboxyl propyl, carboxyl butyl, and C1-C4 alkyl acetate. Exemplary hydrophobically modified polysaccharide for use herein include methyl- and ethyl-cellulose ether, hydroxypropyl-, hydroxybutyl- and hydroxyethyl-methylcellulose ether, hydroxypropyl and hydroxyethyl-cellulose ether, ethylhydroxy ethylcellulose ether, hydroxy ethylcellulose ether, methylhydroxy ethyl carboxy methyl cellulose and carboxymethyl hydroxyethyl cellulose. Most preferably, the modified polysaccharide is hydroxypropyl methylcellulose (HPMC) commercially available under the tradename of Methocel™ from Dow Chemicals. A second type of suitable modified polysaccharide for use herein contains anionic substitutes containing sulfate, sulfonate, carboxylate and/or phosphate groups. Exemplary polysaccharide suitable for anionic modification includes natural or hydrolyzed polysaccharides, as well as hydrophobically modified polysaccrides as described above. Anionic modification can be obtained by sulfating, sulfonating, oxidizing, carboxylating, phosphating natural or hydrolyzed polysaccharides, and/or hydrophobically modified polysaccrides. The degree of substitution (DS) of the anionically modified polysacharide is from about 0.005 to about 1.2, or from about 0.007 to about 0.7. The degree of substitution of the aninically modified polysaccharide is preferably from about 0.007 to about 0.2 for those based on polysaccharide backbones without hydrophobic modification and having a weight average molecular weight of less than 300,000; preferably from about 0.05 to about 0.7 for those based on polysaccharide backbones without hydrophobic modification and having a weight average molecular weight of no less than 300,000; and preferably from about 0.02 to about 0.7 for those based on hydrophobically modified polysaccharides as described above.

### Builders

The present invention is further characterized to comprise less than 15% by weight of a builder selected from phosphate, aluminosilicate and mixtures thereof. Phosphate and aluminosilicate are widely used builders in detergent to “build” or “enhance” the cleaning efficiency of surfactants. In the context of the present invention, builders aid detergency mainly by removing hardness from the wash water (i.e., “softening” water, by reducing the “free” calcium/magnesium ion concentration in the wash solution). Typically, detergent compositions comprise from about 15% to about 40% by weight of the above builder. Reduction of the builder level will typically significantly deteriorate sudsing profile of a detergent composition. However, according to the present invention, the detergent composition may contain less than 15%, or less than 10%, or less than 5%, by weight, or even substantially be free of the phosphate and/or aluminosilicate builder, while the detergent composition still has a satisfied sudsing profile.

As used herein, phosphate builders include the alkali metal, ammonium and alkanolammonium salts of polyphosphates, such as tripolyphosphates, pyrophosphates, and glassy polymeric meta-phosphates. Aluminosilicate builders can be crystalline or amorphous in structure and can be naturally-occurring aluminosilicates or synthetically derived. Preferred synthetic crystalline aluminosilicates useful herein are available under the designations Zeolite A, Zeolite P (B), Zeolite MAP and Zeolite X. In an especially preferred embodiment, the crystalline aluminosilicate has the formula: Na₁₂[(AlO₂)₁₂(SiO₂)].xH₂O, wherein x is from about 20 to about 30, especially about 27. This material is known as Zeolite A.

### Optional Ingredients

The detergent compositions herein may optionally comprise one or more of the optional ingredients typically selected from bleach, chelant, enzyme, anti-redeposition polymer, soil-release polymer, polymeric soil-dispersing and/or soil-suspending agent, dye-transfer inhibitor, fabric-integrity agent, fabric-softening agent, flocculant, perfume, whitening agent, hueing agent, such as photobleach, dyes etc, and mixtures thereof. The precise nature of these additional components, and levels of incorporation thereof will depend on the physical form of the composition or component, and the precise nature of the washing operation for which it is to be used. In one preferred embodiment, the detergent compositions contain from about 0.0001% to 2%, or 0.001% to 0.2% an enzyme selected from proteases, amylases, cellulases, lipases and mixtures thereof.

The detergent composition herein will generally be in the form of a solid composition. Solid compositions include powders, granules, noodles, flakes, bars, tablets, and combinations thereof. The detergent composition herein may also be in the form of a liquid, a paste, a gel, suspension, or any combination thereof. Preferably, the detergent composition is a granular laundry detergent prepared by a spray-drying process or agglomeration process. Typical spray-drying process or agglomeration process known in the art can be used in preparing the granular laundry detergent composition. By way of example, see the processes described in U.S. Pat. No. 5,133,924, U.S. Pat. No. 4,637,891, U.S. Pat. No. 4,726,908, U.S. Pat. No. 5,160,657, U.S. Pat. No. 5,164,108, U.S. Pat. No. 5,569,645. The detergent composition herein can be used to form an aqueous washing solution for use in laundering fabrics. Generally, an effective amount of such compositions is added to water to form such aqueous laundering solutions. The aqueous washing solution so formed is then contacted, preferably under agitation, with the fabrics to be laundered therewith. The laundered fabrics are then rinsed for one or more times with clear water. The laundry detergent composition herein is found to have an improved sudsing profile.

### Test Method

The sudsing profile of the detergent composition herein can be measured by employing a suds cylinder tester (SCT). The SCT has a set of 8 cylinders. Each cylinder is typically 30 cm long and 9 cm in diameter and may be independently rotated at a rate of 20-22 revolutions per minute (rpm). A water solution of a detergent composition to be tested is prepared by dissolving 3.4 g detergent composition into 1000 ml water having water hardness of 17 gpg. The water solution in the cylinder has a height of 16 cm which is deemed to be a constant during the whole test. A scale is sticked on the external wall of each cylinder with 0 starting from the top surface of the cylinder bottom. The SCT rotates at 22 rpm for a time period as specified below, then stop rotation and read the suds height which is the number of the top layer of suds minus the water solution height, 16 cm. The height of the top layer of suds should be the line which crosses the interface of air and dense suds and is vertical to the cylinder wall. Scattered bubbles clinging to the interior surface of the cylinder wall shall not be counted in reading the suds height. The SCT first rotates at 22 rpm for 3 minutes, stop rotation and add 640 μl artificial soil (purchased from Equest, the United States) to each cylinder. The SCT rotates at 22 rpm again, stop rotation and read the suds height every 1 minute for ten times. The average of the ten records is recorded as the suds height of generation 1 (Gen. 1). After taking the ten records of the suds height of generation 1, add 320 μl artificial soil to each cylinder, rotates the SCT at about 22 rpm, stop rotation and read the suds height every 1 minutes for ten times. The average number of the 10 records is recorded as the suds height of generation 2 (Gen. 2). Another 320 μl artificial soil is added to each cylinder and the steps of rotating the SCT and reading the suds height every 1 minute for ten times are repeated. The average number of the 10 records is recorded as the suds height of generation 3 (Gen. 3). Such a test may be used to simulate the initial sudsing profile of a composition, as well as its sudsing profile in washing cycle, as more soils dissolve into the water solution from the fabrics being washed.

Examples of the invention are set forth hereinafter by way of illustration and are not intended to be in any way limiting of the invention. The examples are not to be construed as limitations of the present invention since many variations thereof are possible without departing from its spirit and scope.

### EXAMPLE

Powder detergent compositions having the components shown in below Tables 1-3 are prepared by mixing all the components together. All the percentages in Tables 1-3 are by weight based on the composition of the detergent composition. Sudsing profile of the detergent compositions prepared in the Examples are tested according to the test method described above, suds height data are also shown in the table.

TABLE 1

| | | Comparative | Comparative | Comparative |
|---|---|---|---|---|
| Ingredients | Example 1 | Example 1.1 | Example 1.2 | Example 1.3 |
| LAS¹ | 14% | 14% | 14% | 14% |
| Sodium carbonate | 12% | 12% | 12% | 12% |
| Sodium silicate | 7% | 7% | 7% | 7% |
| MCAE1S² | 2% | | 2% | |
| PEG-PVA graft | 2% | | | 2% |
| copolymer³ | | | | |
| Sodium sulfate | Balance to 100 | | | |
| Suds height of | 3.5 | 1.5 | 2.8 | 2.8 |
| Gen. 1 | | | | |
| Suds height of | 2.8 | 1.7 | 2.5 | 2.3 |
| Gen. 2 | | | | |
| Suds height of | 2.0 | 1.0 | 1.5 | 1.5 |
| Gen. 3 | | | | |

¹LAS is linear C12 alkylbenzene sodium sulfonate;
²MCAE1S is a mid-cut C12-14 alcohol ethoxylate sodium sulphate with an average ethoxylation of 1;
³PEG-PVA graft copolymer is a polyvinyl acetate grafted polyethylene oxide copolymner having a polyethylene oxide bacbone and multiple polyvinyl acetate side chains. The molecular weight of the polyethylene oxide backbone is about 6,000 and the weight ratio of the polyethylene oxide to polyvinyl acetate is about 40 to 60 and no more than 1 grafting point per 50 ethylene oxide units. The surface tension of a 39 ppm PEG-PVA graft copolymer solution in distilled water is about 47.5 mN/m as measured at 25° C. by a Kruss K12 tensiometer and the viscotity of 500 ppm PEG-PVA graft copolymner solution in distilled water is about 0.00093 Pa · s as measured at 25° C. by Thermo Hakke Mars rheometer.

The above data shows that a detergent composition containing no suds boosting co-surfactant and no suds stabilizing surface active polymer (Comparative Example 1.1) has a poor suds performance. In addition, a detergent composition containing only suds boosting co-surfactant (Comparative Example 1.2) or suds stabilizing surface active polymer (Comparative Example 1.3) can improve, to some extent, the suds performance of the detergent composition of Comparative Example 1.1. However, the detergent composition of the present invention (Example 1) has a significant better suds performance versus any of the detergent compositions of Comparative Example 1.1-1.3.

TABLE 2

| | | Comparative | Comparative | Comparative |
|---|---|---|---|---|
| Ingredients | Example 2 | Example 2.1 | Example 2.2 | Example 2.3 |
| LAS¹ | 14% | 14% | 14% | 14% |
| Sodium carbonate | 12% | 12% | 12% | 12% |
| Sodium Silicate | 7% | 7% | 7% | 7% |
| MCAS² | 2% | | 2% | |
| HPMC³ | 2% | | | 2% |
| Sodium sulfate | Balance to 100% | | | |
| Suds height of | 8.8 | 4.1 | 7.5 | 5.3 |
| Gen. 1 | | | | |
| Suds height of | 4.8 | 2.3 | 3.8 | 2.8 |
| Gen. 2 | | | | |
| Suds height of | 3.5 | 1.5 | 2.5 | 2.0 |
| Gen. 3 | | | | |

¹LAS is same to the above definition with regard to Example 1
²MCAS is a mid-cut linear C12-C14 alkyl sulfate
³HPMC is a hydroxypropyl methoxyl cellulose commercially available as Methocel ™ E50 premium LV from Dow Chemical Company. The surface tension of a 39 ppm by weight HPMC solution in distilled water is about 48.2 mN/m as measured at 25° C. by a Kruss K12 tensiometer and the viscotity of 500 ppm by weight HPMC solution in distilled water is about 0.002 Pa · s as measured at 25° C. by Thermo Hakke Mars rheometer.

The above data shows the same trend in terms of suds performance of the detergent composition of the present invention as that of Example 1.

TABLE 3

| | Comparative | Comparative | Comparative |
|---|---|---|---|
| Ingredients | Example 3.1 | Example 3.2 | Example 3.3 |
| LAS¹ | 14% | 14% | 14% |
| Sodium carbonate | 12% | 12% | 12% |
| Sodium Silicate | 7% | 7% | 7% |
| MCAS² | | | 2% |
| AA/MA Copolymer³ | | 2% | 2% |
| Sodium sulfate | Balance to 100% | | |
| Suds height of Gen. 1 | 4.4 | 3.9 | 5.4 |
| Suds height of Gen. 2 | 2.3 | 1.9 | 3.2 |
| Suds height of Gen. 3 | 1.6 | 1.3 | 1.8 |

^{1 2}LAS and MCAS are same to those defined in Example 1 and 2 respectively.
³AA/MA Copolymer is a sodium salt of acrylic acid/maleic acid copolymer having a weight average molecule weight of about 15,000. AA/MA Copolymer does not have the surface active property as defined in the present invention and is typically used in detergent compositions for cleaning purpose. The surface tension of a 39 ppm by weight AA/MA Copolymer solution in distilled water is about 71.4 mN/m as measured at 25° C. by a Kruss K12 tensiometer and the viscotity of 500 ppm by weight AA/MA solution in distilled water is about 0.00094 Pa · s as measured at 25° C. by Thermo Hakke Mars rheometer.

The above data of Comparative Example 3.1 and Comparative Example 3.2 shows that AA/MA Copolymer, as a non-surface active polymer does not improve the suds performance of a detergent composition. In addition, the data of Comparative Example 3.3 shows that AA/MA Copolymer provides barely benefits in improving the suds performance of the detergent composition even in combination with a suds boosting co-surfactant.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A detergent composition comprising:
a. from about 0.2% to about 6% by weight of a suds boosting co-surfactant selected from the group consisting of one or more surfactants having the following formula (I):
R—O—(CH₂CH₂O)ₙSO₃⁻M⁺ (I)
wherein R is a branched or unbranched alkyl group containing from about 8 to about 16 carbon atoms, n is an integer from 0 to 3, M is a cation of alkali metal, alkaline earth metal or ammonium;
b. from about 0.01% to about 5% by weight of a surface active polymer having the following properties:
(i) the surface tension of a 39 ppm polymer solution in distilled water is from about 40 mN/m to about 65 mN/m as measured at 25° C. by a tensiometer; and
(ii) the viscosity of a 500 ppm polymer solution in distilled water is from about 0.0009 to about 0.003 Pa·S as measured at 25° C. by a rheometer;
c. from about 6% to about 15% by weight of a main surfactant system comprising one or more surfactants selected from the group consisting of an anionic surfactant other than the suds boosting co-surfactant, a nonionic surfactant, a cationic surfactant and a zwitterionic surfactant;
wherein said detergent composition comprises less than 20% by weight of total surfactant and less than 15% by weight of a builder selected from the group consisting of a phosphate, an aluminosilicate and a mixture thereof.

2. The detergent composition of claim 1, wherein said main surfactant system is selected from the group consisting of a C11-C18 alkyl benzene sulfonate, a sulfonated fatty acid alkyl ester, a C12-C18 alkyl ethoxylate, a dimethyl hydroxyethyl quaternary ammonium and a mixture thereof.

3. The detergent composition of claim 1, wherein said R group in formula (I) is a C10-C14 linear alkyl group, n is 0.

4. The detergent composition of claim 1, wherein said R group in formula (I) is a branched alkyl group having the following formula (II): 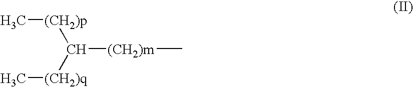
wherein p, q and m are independently selected from integers of 0 to 13, provided that 5≦p+q+m≦13.

5. The detergent composition of claim 4, wherein said m and p are 0, q is an integer of from 5 to 13.

6. The detergent composition of claim 1, wherein said surface active polymer is a co-polymer having a weight average molecular weight of from about 4,000 to about 100,000 comprising from about 40% to about 98% hydrophilic monomers and from about 2% to about 60% hydrophobic monomers.

7. The detergent composition of claim 6, wherein said hydrophilic monomers are selected from the group consisting of an ethylene oxide, an acrylic acid, a methacrylic acid, a maleic acid, a vinyl alcohol, a 2-acrylamido-2-methylpropanesulfonic acid, a methylallyl sulfonate and a mixture thereof and said hydrophobic monomers are selected from the group consisting of a styrene, a propylene oxide, a butylene oxide, a vinyl acetate, a vinyl propionate, a vinyl butyrate, a methyl(meth)acrylate, a butyl(meth)acrylate, a hexyl(meth)acrylate, a lauryl acrylate, a cetyl acrylate, a siloxane, ethylene and a mixture thereof.

8. The detergent composition of claim 6, wherein said co-polymer is a graft co-polymer comprising a hydrophilic backbone and one or more hydrophobic side chains.

9. The detergent composition of claim 8, wherein said hydrophilic backbone of said graft co-polymer is a water-soluble polyalkylene oxides comprising at least 50% by weight of ethylene oxide based on the hydrophilic backbone, and wherein said hydrophobic side chains comprising from about 70% to about 100% by weight of vinyl acetate and/or vinyl propionate based on the hydrophobic side chains.

10. The detergent composition of claim 9, wherein said hydrophilic backbone of said graft co-polymer is polyethylene glycols and said hydrophobic side chains are polyvinyl acetate, wherein said graft co-polymer having an average of no more than 1 graft site per 50 ethylene oxide units.

11. The detergent composition of claim 1, wherein said surface active polymer is a water-soluble modified polysaccharide having a weight average molecular weight of from about 10,000 to about 4,000,000.

12. The detergent composition of claim 11, wherein said water-soluble modified polysaccharide comprises hydrophobic substitutes selected from the group consisting of a carboxyl methyl, a carboxyl ethyl, a carboxyl propyl, a carboxyl butyl, a hydroxybutyl, a hydroxypropyl, a hydroxyethyl, a methoxyl, a C1-C4 alkyl acetate and a mixture thereof with a degree of substitution of from about 0.05 to about 1.2.

13. The detergent composition of claim 11, wherein said water-soluble modified polysaccharide comprises anionic substitutes comprising an anionic moiety selected from the group consisting of a sulfate, a sulfonate, a phosphate, and a carboxylate with a degree of substitution of from about 0.005 to about 1.2.

14. The detergent composition of claim 1, further comprising an enzyme.
